(19) United States
(12) Patent Application Publication
(10) Pub. No.: US 2024/0177725 A1
(43) Pub. Date: May 30, 2024

(54) LOW DATA RATE LANGUAGE COMMUNICATION

(71) Applicant: Product Development Associates, Inc., Burnsville, MN (US)

(72) Inventor: Bradley Vernon BRIERCLIFFE, Burnsville, MN (US)

(21) Appl. No.: 17/994,840

(22) Filed: Nov. 28, 2022

(51) Int. Cl. G10L 19/24; G10L 19/008

(52) U.S. Cl. CPC G10L 19/24; G10L 19/008

(57) ABSTRACT

An encoder apparatus for transmitting language data at a low bitrate. The encoder apparatus may include an encoder input, an encoder output, and processing circuitry. The encoder input may provide language data representative of audible speech or readable text. The encoder output may transmit bitstreams. The processing circuitry may be operatively coupled to the encoder input and encoder output. The processing circuitry may be configured to receive the language data from the encoder input and generate one or more bitstreams based on the received language data. Each of the one or more bitstreams may be representative of a single phoneme. The processing circuitry may further be configured to transmit the one or more bitstreams using the encoder output.

The present disclosure pertains to systems and methods for low data rate language communication.

Voice communication technology is widely distributed and may be easily implemented in most environments. While the bandwidth and data requirements of voice communication generally place only a moderate burden on cellular and Wi-Fi networks, voice data rates may often be in the kilobit per second range and some environments may not or cannot be serviced by cellular or Wi-Fi networks. In such network constrained environments, for example, underwater, over exceptional distances, or in signal denied environments, even voice communication can be a challenge.

### SUMMARY

Language data can be transmitted using bitstreams that each represent a phoneme to allow communication of audible speech or readable text at very low data rates (e.g., 30 bits per second or less). Voice or text may be divided and encoded into a series of phonemes that are each transmitted in a relatively short bitstream. An encoder may receive input that is representative of audible speech or readable text and use such input to generate one or more bitstreams that each represent a single phoneme corresponding to a portion of the input. The encoder may also transmit the one or more bitstreams to be received by one or more systems, devices, or apparatus capable of decoding the one or more bitstreams into audible speech or readable text. The transmitted one or more bitstreams may be received by one or more decoders and each decoder may provide audible speech or readable text based on the one or more bitstreams.

An exemplary encoder apparatus may include an encoder input, an encoder output, and processing circuitry. The encoder input may provide language data representative of audible speech or readable text. The encoder output may transmit bitstreams. The processing circuitry may be operatively coupled to the encoder input and the encoder output. The processing circuitry may be configured to receive the language data from the encoder input and generate one or more bitstreams based on the received language data. Each of the one or more bitstreams may be representative of a single phoneme. The processing circuitry may further be configured to transmit the one or more bitstreams using the encoder output.

An exemplary decoder apparatus may include a decoder input, a decoder output, and processing circuitry. The decoder input may receive bitstreams. Each bitstream may be representative of a single phoneme. The decoder output may provide sound or readable text. The processing circuitry may be operatively coupled to the decoder input and the decoder output. The processing circuitry may be configured to receive one or more bitstreams using the decoder input and provide audible speech or readable text based on the one or more bitstreams using the decoder output.

An exemplary system may include an encoder and a decoder. The encoder may be configured to generate one or more bitstreams based on language data representative of audible speech or readable text. Each of the one or more bitstreams may be representative of a single phoneme. The encoder may be configured to transmit the one or more bitstreams. The decoder may be configured to receive the transmitted one or more bitstreams and provide the audible speech or the readable text based on the one or more bitstreams

An exemplary method may include receiving language data representative of audible speech or readable text using an encoder input, generating one or more bitstreams, and transmitting the one or more bitstreams using an encoder output. Each of the one or more bitstreams may be representative of a single phoneme based on the received language data.

An exemplary method may include receiving one or more bitstreams using a decoder input and providing audible speech or readable text based on the one or more bitstreams using a decoder output. Each of the one or more bitstreams may be representative of a single phoneme.

### BRIEF DESCRIPTION OF THE DRAWINGS

Throughout the specification, reference is made to the appended drawings, where like reference numerals designate like elements, and wherein:

FIG. 1 is a schematic diagram of a system for low data rate language communication according to embodiments described herein.

FIG. 2 is a schematic diagram of a combined encoder/decoder apparatus for low data rate language communication according to embodiments described herein.

FIG. 3 is a schematic diagram of another system for low data rate language communication according to embodiments described herein.

FIG. 4 is a flow diagram of an illustrative method for transmitting one or more bitstreams that each include a single phoneme.

FIG. 5 is a flow diagram of an illustrative method of providing audible speech or readable text based on one or more bitstreams that each include a single phoneme.

### DETAILED DESCRIPTION

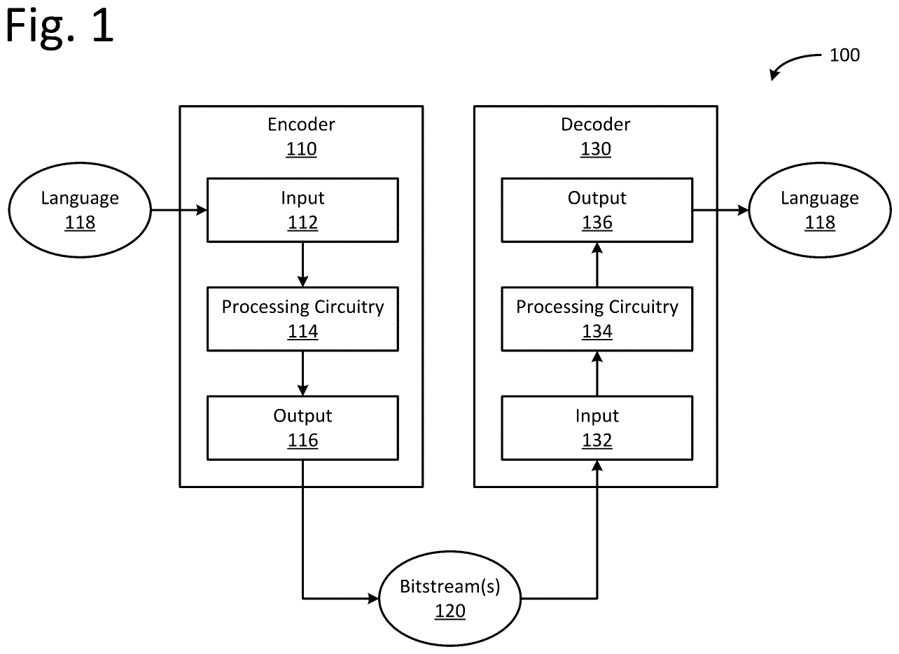

Exemplary methods, apparatus, and systems shall be described with reference to FIGS. 1-5. It will be apparent to one skilled in the art that elements or processes from one embodiment may be used in combination with elements or processes of the other embodiments, and that the possible embodiments of such methods, apparatus, and systems using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

In general, the present disclosure describes various embodiments of encoder and decoder apparatus that are adapted to transmit and receive bitstreams that each include a single phoneme based on language information or data. The disclosure herein will use the terms “language information,” “language data,” and “raw bitstream.” As used herein, it is to be understood that language information may include various forms of language such as, for example, audible speech or readable text. Readable text may be visual or tactile. Visual text may include, for example, images of words in the form of letters or symbols. Tactile text may include, for example, braille or representations of words in the form of letters or symbols that can be perceived by touch. Language information may be represented by signals or encoded into another format. Such representation of language information may be referred to herein as language data. For example, language information in the form of audible speech can be received by a microphone and the microphone can output language data in the form of an analog or digital signal. Additionally, language information may be recorded and stored as language data in memory or other machine-readable formats. In general, data, including language data, may be transmitted using bitstreams. Bitstreams may be used to communicate information or data in the form of an ordered series of bits. Many forms of bitstreams (e.g., transport blocks, frames, ethernet packets, etc.) may include bits representative of headers, flags, checksums, or protocol related information. In contrast, raw bitstreams, as used herein, may only include bits that represent the payload. In other words, a raw bitstream may include only the data (e.g., language data, phonemes, etc.) without additional information about the bitstream.

In network constrained environments, reasonable communication performance may be achieved by a massive increase in signal power levels or a massive reduction in data rates of communication signals. To achieve reduced data rates, the data being transmitted may typically be compressed. The lower the data rate, the more the data may be compressed to allow the data to be transmitted at such low data rates. At low data rates, typical compression methods may lose too much of the original data to be understood. For example, audible speech may be so distorted by some compression methods that the speech can no longer be understood.

Additionally, increases in signal power significant enough to provide reasonable communication performance in some situations may not be appropriate or practical. To provide signal power significant enough for reasonable communication performance, large battery packs may be required when main or wired power is not available. For example, in mobile applications, battery packs large enough to provide enough power for reasonable communication performance may be cumbersome or impractical. Accordingly, such signal constrained communication links may use compression to allow the use of smaller more practical battery packs.

While typical compression algorithms and methods may result in unintelligible results due to distortion at low data rates, the apparatus, system, and methods described herein may provide low bitrate language communication without rendering such communication unintelligible.

Traditional voice communication techniques may digitize or quantize an analog audio signal into a series of values that represent the apparent signal power at a moment in time. Such digitized values may be generated by sampling the analog audio signal many hundreds to thousands of times every second in real-time. Typical voice-frequency transmission channels utilize a 4 kilohertz bandwidth. A sampling rate of 8 kHz may be used, according to the Nyquist-Shannon sampling theorem, to achieve effective reconstruction of a voice signal. Accordingly, uncompressed voice data may have a bit rate of about 8 kilobits per second. To reduce the bit rate of the voice data, the sampled values may be compressed using lossy or lossless compression techniques including, for example, discrete cosine transformations. However, the data rate of the compressed values may still be measured in kilobits per second. The use of typical compression techniques to achieve data rates below 1 kilobit per second may distort the voice data to a degree that audio generated from the compressed values may be unintelligible. Accordingly, compression techniques that allow for intelligible transmission of language communication at low data rates (e.g., below 100 bits per second) may be desirable.

Voice communication may consist of up to 44 phonemes regardless of the language being spoken. Phonemes may refer to the perceptually distinct units of sound that human languages are built from. When speaking, phonemes may be produced for many hundreds of milliseconds as a speaker strings a series of phonemes together to generate speech. Thus, audible speech or readable text may be represented as a stream of phonemes rather than digital samples taken at a rate of about 8 kilohertz.

A stream of phonemes may represent language more efficiently than a compressed stream of sampled audio. Each phoneme may be assigned a numerical value. As each phoneme is detected by a system or apparatus, its corresponding numeric representation may be transmitted. Because the phonemes may be produced for a relatively long period of time, and only a single number needs to be transmitted to represent a single phoneme, the effective data rate may be very low (e.g., less than 50 bits per second).

The 44 different phonemes that human speakers can generate can be represented by a 6-bit number because a 6-bit number can encode up to 64 discrete values. A typical phoneme may have a duration of about 200 milli-seconds. When each phoneme is represented by a 6-bit number, the transmission of a single phoneme generates 6-bits every 200 milliseconds or 30 bits per second. Additionally, there may be no transmission of data when a speaker is silent. Thus, the effective transmission may be further reduced to 20 bits per second or less depending on the cadence of the speaker. The transmission rate may also be reduced using an optimization scheme such as, for example, Huffman encoding. By using such optimization schemes to assign numbers to the phonemes, the average number of encoding bits per phoneme can be reduced to about 4. The particular encoding scheme may change based on the language being encoded and the probability of a given phoneme occurring in the language as spoken. More common phonemes may be assigned shorter bit patterns, generally resulting in an average of 4 bits representing the phonemes. Accordingly, the effective transmission rate can be reduced to 15 bits per second or less.

Processing circuitry may detect and generate phoneme streams (e.g., bitstreams representative of phonemes) from a spoken language (e.g., audible speech) in real-time. The phoneme streams may be transmitted and subsequently decoded to reproduce the spoken language or to represent the spoken language as readable text. Transmission of readable text may also have a correspondingly low data rate relative to typical transmission of readable text. For example, the message “hello from underwater,” can be encoded as 21 discrete numeric values (one per each message character). Each letter can be represented by a 5-bit value (32 possible encodings when only 26 are needed for each letter of the alphabet plus white space encoding and special case signaling characters). If this message takes 3 seconds to vocalize, then the effective transmission rate required is (21 characters*5 bits) every 3 seconds or 35 bits per second. Accordingly, the bit rate may be significantly higher than a phoneme transmission scheme or method (e.g., nearly double).

While the phoneme transmission apparatus, systems, and methods described herein use a form of compression to achieve low bitrate language communication, any information that may be lost does not affect the intelligibility of the resultant audible speech or readable text. Instead, reproduction of audible speech from bitstreams that each include a single phoneme may result in the voice of the original speaker being unrecognizable because the bitstreams do not carry information that corresponds to slight variations in phoneme sounds produced by the original speaker. In general, different speakers may be recognized by slight variations in phoneme sounds because different speakers generally produce phoneme sounds slightly different from each other. Typically, unique phonetic variations may allow others to learn to recognize specific speakers. For situations where identifying the current speaker may be necessary, an additional message or bitstream can be included in the transmission to identify the current speaker (e.g., Speaker #5). Furthermore, decoder processing circuitry may be configured to recreate the original voice characteristics of the current speaker. In other words, the phonemes reproduced by a decoder apparatus may match the vocalization patterns of the current speaker.

Accordingly, the apparatus, systems, and methods described herein may allow for a significant increase in data compression for language communication over other existing methods, while at the same time minimizing the distortion of the original message.

The invention is defined in the claims. However, below there is provided a non-exhaustive list of non-limiting examples. Any one or more of the features of these examples may be combined with any one or more features of another example, embodiment, or aspect described herein.

Example Ex1: An encoder apparatus comprising: an encoder input to provide language data representative of audible speech or readable text; an encoder output to transmit bitstreams; and processing circuitry operatively coupled to the encoder input and the encoder output and configured to: receive the language data from the encoder input; generate one or more bitstreams based on the received language data, each of the one or more bitstreams representative of a single phoneme; and transmit the one or more bitstreams using the encoder output.

Example Ex2: The apparatus as in example Ex1, wherein each of the one or more bitstreams is a raw bitstream.

Example Ex3: The apparatus as in any one of the previous examples, wherein each of the one or more bitstreams comprises at least 4 bits and no greater than 6 bits.

Example Ex4: The apparatus as in any one of examples Ex1 or Ex2, wherein each of the one or more bitstreams comprises 6 bits.

Example Ex5: The apparatus as in any one of the previous examples, wherein the processing circuitry is configured to transmit the one or more bitstreams at a rate of 30 bits per second or less.

Example Ex6: The apparatus as in any one of the previous examples, wherein transmission of the one or more bitstreams comprises a transmission gap of at least 1 millisecond and no greater than 10 milliseconds between transmission of two sequential bitstreams of the one or more bitstreams.

Example Ex7: The apparatus as in any one of the previous examples, wherein the encoder input comprises an audio transducer configured to receive the audible speech and provide the language data based on the audible speech.

Example Ex8: The apparatus as in any one of the previous examples, wherein the encoder input comprises a user interface configured to receive user input representative of the readable text and provide the language data based on the user input.

Example Ex9: A decoder apparatus comprising: a decoder input to receive bitstreams, each bitstream representative of a single phoneme; a decoder output to provide sound or readable text; and processing circuitry operatively coupled to the decoder input and the decoder output and configured to: receive one or more bitstreams using the decoder input; and provide audible speech or readable text based on the one or more bitstreams using the decoder output.

Example Ex10: The apparatus as in example Ex9, wherein each of the one or more bitstreams are raw bitstreams.

Example Ex11: The apparatus as in any one of examples Ex9 or Ex10, wherein to provide the audible speech or the readable text, the processing circuitry is configured to: generate one or more signals representative of the audible speech or the readable text based on the received one or more bitstreams; and provide the one or more signals to the decoder output.

Example Ex12: The apparatus as in any one of examples Ex9 to Ex11, wherein the decoder output comprises a display and providing the audible speech or the readable text comprises displaying text representative of each phoneme represented by the one or more bitstreams using the display.

Example Ex13: The apparatus as in any one of examples Ex9 to Ex12, wherein the decoder output comprises an audio transducer configured to generate sound and providing the audible speech or the readable text comprises generating sound comprising each phoneme represented by the one or more bitstreams using the audio transducer.

Example Ex14: The apparatus as in any one of examples Ex9 to Ex13, wherein the processing circuitry is further configured to determine an occurrence of a transmission error based on a pair of phonemes corresponding to two sequential bitstreams of the received one or more bitstreams.

Example Ex15: A system comprising: an encoder configured to: generate one or more bitstreams based on language data representative of audible speech or readable text, each of the one or more bitstreams representative of a single phoneme; and transmit the one or more bitstreams; and a decoder configured to:

receive the transmitted one or more bitstreams; and provide the audible speech or the readable text based on the one or more bitstreams.

Example Ex16: The system as in example Ex15, wherein each of the one or more bitstreams is a raw bitstream.

Example Ex17: The system as in any one of examples Ex15 or Ex16, wherein each of the one or more bitstreams comprises at least 4 bits and no greater than 6 bits.

Example Ex18: The system as in any one of examples Ex15 or Ex16, wherein each of the one or more bitstreams comprises 6 bits.

Example Ex19: The system as in any one of examples Ex15 to Ex18, wherein transmitting the one or more bitstreams comprises transmitting the one or more bitstreams at a rate of 30 bits per second or less.

Example Ex20: The system as in any one of examples Ex15 to Ex19, wherein transmission of the one or more bitstreams comprises a transmission gap of at least 1 millisecond and no greater than 10 milliseconds between transmission of two sequential bitstreams of the one or more bitstreams.

Example Ex21: The system as in any one of examples Ex15 to Ex20, wherein the encoder comprises an encoder input comprising an audio transducer configured to receive the audible speech and provide the language data based on the audible speech.

Example Ex22: The system as in any one of examples Ex15 to Ex21, wherein the encoder comprises an encoder input comprising a user interface configured to receive user input representative of the readable text and provide the language data based on the user input.

Example Ex23: The system as in any one of examples Ex15 to Ex22, wherein the decoder comprises: a decoder output; and processing circuitry operatively coupled to the decoder output, wherein to provide the audible speech or the readable text, the processing circuitry is configured to: generate one or more signals representative of the audible speech or the readable text based on the received one or more bitstreams; and provide the one or more signals to the decoder output.

Example Ex24: The system as in any one of examples Ex15 to Ex23, wherein the decoder comprises a decoder output comprising a display and providing the audible speech or the readable text comprises displaying text representative of each phoneme represented by the one or more bitstreams using the display.

Example Ex25: The system as in any one of examples Ex15 to Ex24, wherein the decoder comprises a decoder output comprising an audio transducer and providing the audible speech or the readable text comprises generating sound that comprises each phoneme represented by the one or more bitstreams using the audio transducer.

Example Ex26: The system as in any one of examples Ex15 to Ex25, wherein the decoder comprises processing circuitry configured to determine an occurrence of a transmission error based on a pair of phonemes corresponding to two sequential bitstreams of the received one or more bitstreams.

Example Ex27: A method for low bitrate language communication, the method comprising: receiving language data representative of audible speech or readable text using an encoder input; generating one or more bitstreams, each of the one or more bitstreams representative of a single phoneme based on the received language data; and transmitting the one or more bitstreams using an encoder output.

Example Ex28: The method as in example Ex27, wherein each of the one or more bitstreams is a raw bitstream.

Example Ex29: The method as in any one of examples Ex27 or Ex28, wherein each of the one or more bitstreams comprises at least 4 bits and no greater than 6 bits.

Example Ex30: The method as in any one of examples Ex27 or Ex28, wherein each of the one or more bitstreams comprises 6 bits.

Example Ex31: The method as in any one of examples Ex27 to Ex30, wherein transmitting the one or more bitstreams comprises transmitting the one or more bitstreams at a rate of 30 bits per second or less.

Example Ex32: The method as in any one of examples Ex27 to Ex31, wherein transmission of the one or more bitstreams comprises a transmission gap of at least 1 millisecond and no greater than 10 milliseconds between transmission of two sequential bitstreams of the one or more bitstreams.

Example Ex33: A method for low bitrate language communication, comprising: receiving one or more bitstreams using a decoder input, each of the one or more bitstreams representative of a single phoneme; and providing audible speech or readable text based on the one or more bitstreams using a decoder output.

Example Ex34: The method as in example Ex33, wherein each of the one or more bitstreams are raw bitstreams.

Example Ex35: The method as in any one of examples Ex33 or Ex34, wherein providing the audible speech or the readable text comprises: generating one or more signals representative of the audible speech or the readable text based on the received one or more bitstreams; and providing the one or more signals to the decoder output.

Example Ex36: The method as in any one of examples Ex33 to Ex35, wherein the decoder output comprises a display and providing the audible speech or the readable text comprises displaying the readable text using the display.

Example Ex37: The method as in any one of examples Ex33 to Ex36, wherein the decoder output comprises an audio transducer and providing the audible speech or the readable text comprises generating sound that includes each phoneme represented by the one or more bitstreams.

Example Ex38: The method as in any one of examples Ex33 to Ex37, further comprising determining an occurrence of a transmission error based on a pair of phonemes corresponding to two sequential bitstreams of the received one or more bitstreams.

Example Ex39: A method for low bitrate language communication, comprising: receiving language data representative of audible speech or readable text from using an encoder input; generating one or more bitstreams, each of the one or more bitstreams representative of a single phoneme based on the received language data;
transmitting the one or more bitstreams using an encoder output; receiving the transmitted one or more bitstreams using a decoder input; and providing the audible speech or the readable text based on the one or more bitstreams using a decoder output.

Example Ex40: The method as in example Ex39, wherein each of the one or more bitstreams is a raw bitstream.

Example Ex41: The method as in any one of examples Ex39 or Ex40, wherein each of the one or more bitstreams comprises at least 4 bits and no greater than 6 bits.

Example Ex42: The method as in any one of examples Ex39 or Ex40, wherein each of the one or more bitstreams comprises 6 bits.

Example Ex43: The method as in any one of examples Ex39 to Ex42, wherein transmitting the one or more bitstreams comprises transmitting the one or more bitstreams at a rate of 30 bits per second or less.

Example Ex44: The method as in any one of examples Ex39 to Ex43, wherein transmission of the one or more bitstreams comprises a transmission gap of at least 1 millisecond and no greater than 10 milliseconds between transmission of two sequential bitstreams of the one or more bitstreams.

Example Ex45: The method as in any one of examples Ex39 to Ex44, wherein the decoder output comprises a display and providing the audible speech or the readable text comprises displaying text representative of each phoneme represented by the one or more bitstreams using the display.

Example Ex46: The method as in any one of examples Ex39 to Ex45, wherein the decoder output comprises an audio transducer and providing the audible speech or the readable text comprises generating sound that comprises each phoneme represented by the one or more bitstreams using the audio transducer.

Example Ex47: The method as in any one of examples Ex39 to Ex46, further comprising determining an occurrence of a transmission error based on a pair of phonemes corresponding to two sequential bitstreams of the received one or more bitstreams.

Example Ex48: An encoder/decoder apparatus comprising: an input to provide language data representative of audible speech or readable text; an output to provide sound or readable text; a transceiver to transmit and receive bitstreams; and processing circuitry operatively coupled to the input, the output, and the transceiver and configured to: transmit or receive one or more bitstreams using the transceiver, each of the one or more bitstreams representative of a single phoneme; and generate the one or more bitstreams based on the language data provided by the input; or provide, using the output, audible speech or readable text based on the received one or more bitstreams.

Example Ex49: The apparatus as in example Ex48, wherein each of the one or more bitstreams is a raw bitstream.

Example Ex50: The apparatus as in example any one of examples Ex48 or Ex49, wherein each of the one or more bitstreams comprises at least 4 bits and no greater than 6 bits.

Example Ex51: The apparatus as in example any one of examples Ex48 or Ex49, wherein each of the one or more bitstreams comprises 6 bits.

Example Ex52: The apparatus as in example any one of examples Ex48 to Ex51, wherein the processing circuitry is configured to transmit the one or more bitstreams at a rate of 30 bits per second or less.

Example Ex53: The apparatus as in example any one of examples Ex48 to Ex52, wherein transmission of the one or more bitstreams comprises a transmission gap of at least 1 millisecond and no greater than 10 milliseconds between transmission of two sequential bitstreams of the one or more bitstreams.

Example Ex54: The apparatus as in example any one of examples Ex48 to Ex53, wherein the input comprises an audio transducer configured to receive the audible speech and provide the language data based on the audible speech.

Example Ex55: The apparatus as in example any one of examples Ex48 to Ex54, wherein the input comprises a user interface configured to receive user input representative of the readable text and provide the language data based on the user input.

Example Ex56: The apparatus as in example any one of examples Ex48 to Ex55, wherein to provide the audible speech or the readable text, the processing circuitry is configured to: generate one or more signals representative of the audible speech or the readable text based on the received one or more bitstreams; and provide the one or more signals to the output.

Example Ex57: The apparatus as in example any one of examples Ex48 to Ex56, wherein the output comprises a display and providing the audible speech or the readable text comprises displaying text representative of each phoneme represented by the one or more bitstreams using the display.

Example Ex58: The apparatus as in example any one of examples Ex48 to Ex57, wherein the output comprises an audio transducer configured to generate sound and providing the audible speech or the readable text comprises generating sound comprising each phoneme represented by the one or more bitstreams using the audio transducer.

Example Ex59: The apparatus as in example any one of examples Ex48 to Ex58, wherein the processing circuitry is further configured to determine an occurrence of a transmission error based on a pair of phonemes corresponding to two sequential bitstreams of the received one or more bitstreams.

Example Ex60: A system comprising a plurality of nodes, the plurality of nodes comprising: a first node comprising: an input to provide language data representative of audible speech or readable text; a transmitter to transmit bitstreams; and processing circuitry operatively coupled to the input and the transmitter and configured to: receive the language data; generate one or more bitstreams based on the language data, each of the one or more bitstreams representative of a single phoneme; and transmit one or more bitstreams using the transmitter.

Example Ex61: The apparatus as in example Ex60, wherein each of the one or more bitstreams is a raw bitstream.

Example Ex62: The apparatus as in any one of examples Ex60 or Ex61, wherein each of the one or more bitstreams comprises at least 4 bits and no greater than 6 bits.

Example Ex63: The apparatus as in any one of examples Ex60 or Ex61, wherein each of the one or more bitstreams comprises 6 bits.

Example Ex64: The apparatus as in any one of examples Ex60 to Ex63, wherein the processing circuitry is configured to transmit the one or more bitstreams at a rate of 30 bits per second or less.

Example Ex65: The apparatus as in any one of examples Ex60 to Ex64, wherein transmission of the one or more bitstreams comprises a transmission gap of at least 1 millisecond and no greater than 10 milliseconds between transmission of two sequential bitstreams of the one or more bitstreams.

Example Ex66: The apparatus as in any one of examples Ex60 to Ex65, wherein the input comprises an audio transducer configured to receive the audible speech and provide the language data based on the audible speech.

Example Ex67: The apparatus as in any one of examples Ex60 to Ex66, wherein the input comprises a user interface configured to receive user input representative of the readable text and provide the language data based on the user input.

Example Ex68: The apparatus as in any one of examples Ex60 to Ex67, wherein the plurality of nodes comprises a second node comprising: a receiver to receive bitstreams; an output to provide sound or readable text; and processing circuitry operatively coupled to the receiver and the output and configured to: receive the one or more bitstreams using the receiver; and provide, using the output, audible speech or readable text based on the received one or more bitstreams.

Example Ex69: The apparatus as in any one of examples Ex60 to Ex68, wherein to provide the audible speech or the readable text, the processing circuitry of the second node is configured to: generate one or more signals representative of the audible speech or the readable text based on the received one or more bitstreams; and provide the one or more signals to the output.

Example Ex70: The apparatus as in any one of examples Ex60 to Ex69, wherein the output comprises a display and providing the audible speech or the readable text comprises displaying text representative of each phoneme represented by the one or more bitstreams using the display.

Example Ex71: The apparatus as in any one of examples Ex60 to Ex70, wherein the output comprises an audio transducer configured to generate sound and providing the audible speech or the readable text comprises generating sound comprising each phoneme represented by the one or more bitstreams using the audio transducer.

Example Ex72: The apparatus as in any one of examples Ex60 to Ex71, wherein the processing circuitry of the second node is further configured to determine an occurrence of a transmission error based on a pair of phonemes corresponding to two sequential bitstreams of the received one or more bitstreams.

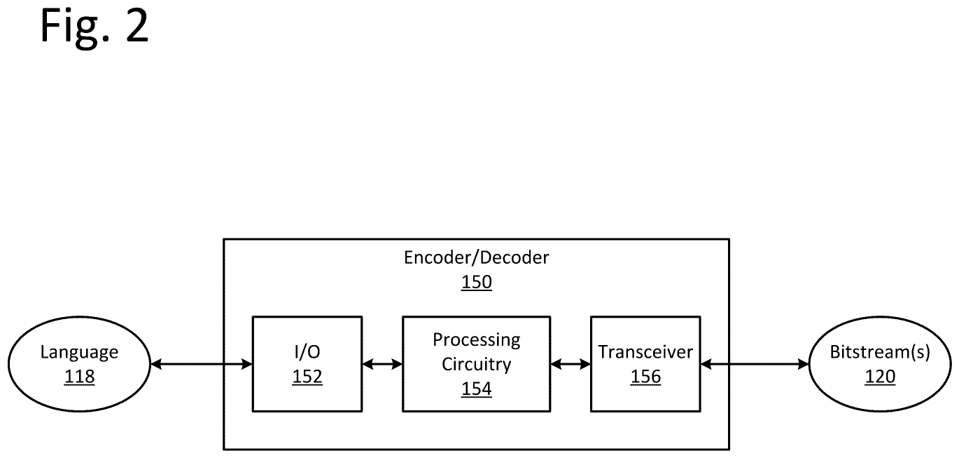

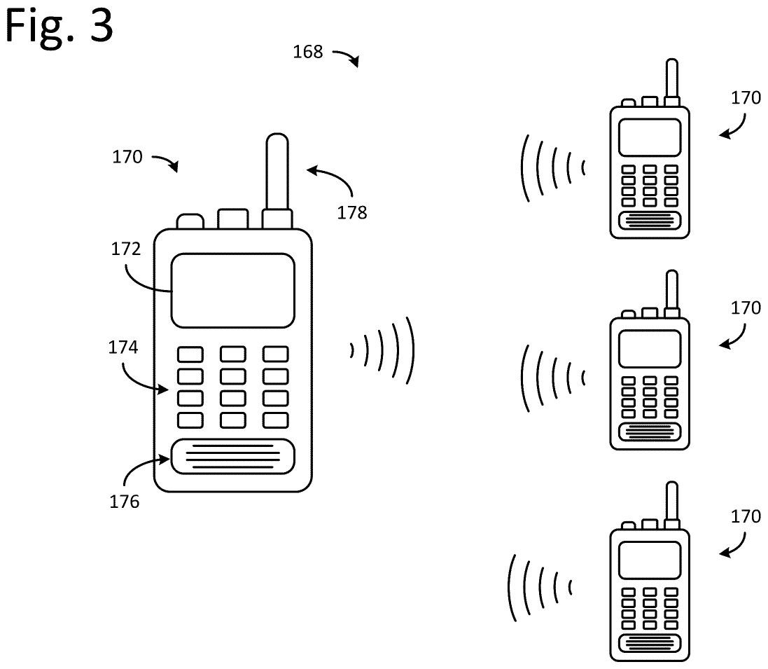

To facilitate low data rate language communication, each transmitter may include an encoder apparatus and each receiver may include a decoder apparatus. In one or more embodiments, transceivers may include components of both an encoder apparatus and a decoder apparatus. An exemplary system that includes individual encoder and decoder apparatus is depicted in FIG. 1, an exemplary combination encoder/decoder apparatus is depicted in FIG. 2, and another exemplary system that includes a plurality of nodes that each may include an encoder, a decoder, or a combined encoder/decoder is depicted in FIG. 3.

FIG. 1 shows an exemplary system 100 including an encoder 110 and a decoder 130. The encoder 110 may include an encoder input 112, processing circuitry 114, and an encoder output 116. The encoder input 112 may be configured to, or adapted to, receive language information 118. Additionally, the encoder input 112 may be configured to provide language data representative of audible speech or readable text. The encoder input 112 may include any suitable interface or connector for receiving language information 118 such as, e.g., a Universal Serial Bus (USB), a DIN connector (e.g., PS/2, MIDI, etc.), a tip-ring-sleeve connector, a computer mouse, a keyboard, a universal serial bus (USB) device, etc. The encoder input 112, may be operatively coupled to and receive language information from any suitable source such as, e.g., a computer, an audio transducer, a sensor, a keyboard, a mouse, etc. The encoder input 112 may receive language information such as audible speech or readable text and provide language data representative of the received audible speech or readable text. In one or more embodiments, the encoder input 112 may include an audio transducer configured to receive audible speech and provide language data based on the audible speech. In one or more embodiments, the encoder input 112 may include a user interface configured to receive user input representative of readable text and provide language data based on the user input.

The processing circuitry 114 may be operatively coupled to the encoder input 112 and configured to receive the language data from the encoder input 112. Once the language data, or a portion thereof, has been received, the processing circuitry 114 may generate one or more bitstreams 120, each of the one or more bitstreams including a single phoneme. The processing circuitry 114 may determine one or more phonemes based on the language data. In other words, the one or more phonemes may be determined such that the one or more phonemes can be combined to reproduce the language information represented by the language data. Accordingly, the number of generated bitstreams may be equivalent to the number of phonemes contained in the language information 118 or language data derived therefrom. Additionally, the processing circuitry 114 may be operatively coupled to the encoder output 116 to provide the one or more bitstreams to the encoder output 116. Thus, after each bitstream 120 has been generated, the processing circuitry 114 may transmit the one or more bitstreams 120 using the encoder output 116.

The processing circuitry 114 may include any suitable hardware or devices to receive language data, generate bitstreams 120, convert language data to phonemes, assign values to phonemes, control the generation of bitstreams 120, transmit bitstreams 120 using an output (e.g., transmitter or transceiver), etc. The processing circuitry 114 may include, e.g., one or more processors, logic gates, clocks, queues and First-In-First-Out (FIFO) for holding intermediate data packages, Electro-Static Discharge (ESD) protection circuitry for input and output signals, line drivers and line decoders for interfacing to external devices, etc. The processing circuitry 114 may be provided in a Field-Programmable Gate Array (FPGA), a circuit board, a system on a chip, a fixed or mobile computer system (e.g., a personal computer or minicomputer), implemented in software, etc. In one example, processing circuitry 114 is implemented in an FPGA.

The exact configuration of the processing circuitry 114 is not limiting and essentially any device capable of providing suitable computing capabilities and signal processing capabilities (e.g., interpret language data, generate bitstreams 120, convert video data formats, etc.) may be used. Further, various peripheral devices, such as a computer display, mouse, keyboard, memory, printer, scanner, etc. are contemplated to be used in combination with the processing circuitry 114 or encoder 110. Further, in one or more embodiments, data (e.g., language data, phoneme data, speech-to-text data, speaker data, etc.) may be analyzed by a user, used by another machine that provides output based thereon, etc. As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by processing circuitry 114 described herein. Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware that is to be used to implement the processes described herein shall not be limiting on the scope of the systems, processes, or programs (e.g., the functionality provided by such systems, processes, or programs) described herein.

The methods and processes described in this disclosure, including those attributed to the systems, or various constituent components, may be implemented, at least in part, in hardware, software, firmware, or any combination thereof. For example, various aspects of the techniques may be implemented by the processing circuitry 114, which may use one or more processors such as, e.g., one or more microprocessors, DSPs, ASICS, FPGAs, CPLDs, microcontrollers, or any other equivalent integrated or discrete logic circuitry, as well as any combinations of such components, image processing devices, or other devices. The term “processing apparatus,” “processor,” or “processing circuitry” may generally refer to any of the foregoing logic circuitry, alone or in combination with other logic circuitry, or any other equivalent circuitry. Additionally, the use of the word “processor” may not be limited to the use of a single processor but is intended to connote that at least one processor may be used to perform the exemplary methods and processes described herein.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and methods described in this disclosure may be embodied as instructions on a computer-readable medium such as RAM, ROM, NVRAM, EEPROM, FLASH memory, magnetic data storage media, optical data storage media, or the like. The instructions may be executed by the processing circuitry 114 to support one or more aspects of the functionality described in this disclosure.

The processing circuitry 114 may be further described as being configured to receive any language data stream and to generate and transmit bitstreams 120 including data representative of the language information 118. Each bitstream 120 generated by processing circuitry 114 may include a single phoneme that represents a portion of the language information 118. Bitstreams generated by the processing circuitry 114 may be raw bitstreams. As used herein, raw bitstreams may refer to bitstreams that include only the payload (e.g., language data, phonemes, speaker/user data, etc.) without additional information about the bitstream. Each bitstream 120 generated by the processing circuitry 114 may include at least 1 bit and no greater than 6 bits. In one or more embodiments, the one or more bitstreams 120 include at least 4 bits and no greater than 6 bits. In one or more embodiments, each of the one or more bitstreams 120 include 6 bits. In other words, the bitstreams may be no less and no greater than 6 bits long.

The processing circuitry 114 may be configured to transmit the one or more bitstreams 120 at a rate of 30 bits per second or less. In one or more embodiments, the processing circuitry 114 may be configured to transmit the one or more bitstreams 120 at a rate of 20 bits per second or less. Furthermore, the processing circuitry 114 may be configured to insert a transmission gap between each of the one or more bitstreams 120. In other words, transmission of the one or more bitstreams may include a transmission gap between transmission of two sequential bitstreams of the one or more bitstreams. Such transmission gaps may indicate the end of each bitstream. Transmission gaps between bitstreams may allow individual bitstreams can be readily identified, even when the bitstreams 120 are of a variable length. However, individual fixed length bit streams (e.g., 6-bit bitstreams) may be readily identified without any transmission gaps. The encoder output 116 may transmit bitstreams 120. The encoder output 116 may include any suitable connector or interface for transmitting bitstreams or other data such as, for example, an Attachment Unit Interface (AUI), an N connector, a vampire tap, a Bayonet Neill-Councilmen (BNC) connector, Small Form Factor Pluggable (SFP+), Registered Jack (RJ), a network interface card, an antenna, etc. Additionally, the encoder output 116 may be operatively coupled to any suitable device such as, for example, a network, a computer, a switch, a decoder device, a network bridging device, a range extender, an antenna, etc. The encoder output 116 may transmit bitstreams 120 to any operatively coupled device such as, for example, a decoder (e.g., decoder 130) or other device configured to receive transmitted bitstreams 120. In one or more embodiments, the encoder output 116 may be configured to transmit bitstreams 120 using wireless signals. Bitstreams 120 transmitted using wireless signals may be received by any suitable device configured to receive bitstreams via a wireless signal.

The decoder apparatus 130 may receive transmitted bitstreams 120 and generate language information 118 based on the received bitstreams 120. The decoder 130 may include a decoder input 132, processing circuitry 134, and decoder output 136. The decoder input 132 may include any suitable device or devices to receive bitstreams or other data (e.g., bitstreams 120) such as, for example, an Attachment Unit Interface (AUI), an N connector, a vampire tap, a Bayonet Neill-Councilmen (BNC) connector, Small Form Factor Pluggable (SFP+), Registered Jack (RJ), a network interface card, an antenna, etc. Additionally, the encoder output 116 may be operatively coupled to any suitable device such as, for example, a network, a computer, a switch, a decoder device, a network bridging device, a range extender, an antenna, etc. The decoder input 132 may receive bitstreams 120 from any operatively coupled device such as, for example, an encoder (e.g., encoder 110) or other device configured to transmit bitstreams 120. In one or more embodiments, the decoder input 132 may be configured to receive bitstreams 120 in the form of wireless signals.

The processing circuitry 134 may receive one or more bitstreams 120 from the decoder input 132. Once one or more bitstreams 120, each including a single phoneme, have been received, the processing circuitry 134 may provide audible speech or readable text based on the one or more bitstreams 120 using the decoder output 136. To provide audible speech or readable text, the processing circuitry 134 may be configured to generate one or more signals representative of the audible speech or readable text based on the received one or more bitstreams 120 and provide the one or more signals to the decoder output 136.

The processing circuitry 134 may include any suitable hardware or devices to provide audible speech or readable text based on the one or more bitstreams 120. The processing circuitry 134 may include, e.g., one or more processors, logic gates, clocks, buffers, memory, decoders, queues and First-In-First-Out (FIFO) for holding intermediate data packages, Electro-Static Discharge (ESD) protection circuitry for input and output signals, line drivers and line decoders for interfacing to external devices, etc. The processing circuitry 134 may be provided in a Field-Programmable Gate Array (FPGA), a circuit board, a system on a chip, a computer, implemented with software, etc. In one example, processing circuitry 134 is implemented in an FPGA. The exact configuration of the processing circuitry 134 is not limiting and may be similar to configurations previously discussed herein with respect to the processing circuitry 114. Thus, the processing circuitry 134 may be configured to receive bitstreams 120 and to provide audible speech or readable text based on the one or more bitstreams 120. Each bitstream 120 received by processing circuitry 134 may include a single phoneme that represents a portion of language information 118.

The processing circuitry 134 may be configured to parse or identify individual bitstreams of the one or more bitstreams 120. In other words, the processing circuitry 134 may be configured to determine when one bitstream ends and another begins. The processing circuitry 134 may be configured to identify individual bitstreams based on a fixed bitstream length. For example, each bitstream may have a fixed length (e.g., 6 bits) and the processing circuitry 134 may be configured to divide the one or more bitstreams into bitstreams corresponding to the fixed length. Additionally, or alternatively, the processing circuitry 134 may be configured to identify individual bitstreams based on a transmission gap between sequential bitstreams. For example, when a threshold period of time elapses between the reception of two bits, the processing circuitry 134 may determine that one bitstream ended before the transmission gap and another bitstream began after the transmission gap. The threshold period of time may be at least 1 millisecond and no greater than 10 milliseconds.

The processing circuitry 134 may also be configured to determine an occurrence of a transmission error based on a pair of phonemes corresponding to two sequential bitstreams of the received one or more bitstreams 120. Such determination of the occurrence of a transmission error may be based on a language being spoken. In general, there are some phonemes in spoken language that may not occur sequentially. Accordingly, the processing circuitry 134 may be configured to identify when the phonemes of two sequential bitstreams correspond to a phoneme order that should not occur in a given language. The language may be predetermined in hardware or software or may be selectable by a user. In response to a determination that a transmission error occurred, the processing circuitry may be configured to provide a transmission error message using the decoder output 136.

The decoder output 136 may include any suitable connector or interface for receiving language data (e.g., signals representative of language data) and providing language information 118. The decoder output 136 may include, for example, Video Graphics Array (VGA), RS-343, High-Definition Multimedia Interface (HDMI), Digital Visual Interface (DVI), a DisplayPort (DP), carried as DisplayPort protocol over USB 3.0, 3.1, National Television Standard Committee (NTSC)-RS170, a display, a graphical user interface, audio transducers, etc. The decoder output 136, may be operatively coupled to and receive one or more signals (e.g., one or more signals representative of audible speech or readable text) from processing circuitry 134. Additionally, the decoder output 136 may be operatively coupled to any other suitable device to provide language information 118 such as, e.g., a computer, a monitor, a television, projection screen, other video transmission device, tactile communication devices (e.g., braille display, braille notetaker, etc.), audio transducers (e.g., microphones, speakers, etc.), etc. In one or more embodiments, the decoder output 136 may include a display and providing the audible speech or the readable text includes displaying text representative of each phoneme represented by the one or more bitstreams 120 using the display. In one or more embodiments, the decoder output 136 may include an audio transducer configured to generate sound and providing the audible speech or the readable text includes generating sound including each phoneme represented by the one or more bitstreams using the audio transducer.

Although described separately with regard to the system 100 of FIG. 1, an encoder and decoder can be included in a single device or apparatus. An exemplary encoder/decoder apparatus 150 is depicted in FIG. 2. The encoder/decoder 150 may include one or more inputs and outputs (I/O devices) 152, processing circuitry 154, and a transceiver 156. The encoder/decoder 150 may receive or provide language information 118 and/or language data using the I/O devices 152 and transmit and receive bitstreams 120 using the transceiver 156.

The one or more I/O devices 152 may include any suitable interface or connector as described herein with regard to the encoder input 112 and the decoder output 136 of FIG. 1 as described herein. Furthermore, the one or more I/O devices 152 may be configured to, or adapted to, carry out any of the processes or steps described herein with regard to the encoder input 112 and the decoder output 136 of FIG. 1. In other words, the one or more I/O devices 152 may include some or all of the devices and functionality of the encoder input 112 and the decoder output 136 of FIG. 1.

Similarly, the transceiver 156 may include any suitable interface or connector as described herein with regard to the encoder output 116 or the decoder input 132 of FIG. 1. Additionally, the transceiver 156 may be configured to, or adapted to, carry out any of the processes or steps described herein with regard to the encoder output 116 and the decoder input 132. In other words, the transceiver 156 may include some or all of the devices and functionality of the encoder output 116 and the decoder input 132 of FIG. 1. Furthermore, the transceiver 156 may include a separate receiver and transmitter or a receiver and transmitter combined in a single package.

The processing circuitry 154 may be operatively coupled to the one or more I/O devices 152 and the transceiver 156. The processing circuitry 154 may include any of the hardware or devices of the processing circuitry 114 and 134 of FIG. 1. Additionally, the processing circuitry 154 may be configured, or adapted to, carry out any of the methods, steps, or processes described herein for low data rate language communication described herein including the methods, steps, or processes described herein with regard to the processing circuitry 114 and 134 of FIG. 1. In other words, the processing circuitry 154 may be configured to carry out any one or more of, for example, receiving language data representative of audible speech or readable text using an input (e.g., encoder input 112, I/O devices 152, etc.), generating one or more bitstreams based on received language data, transmitting the one or more bitstreams using an output (e.g., encoder output 116, I/O devices 152, etc.), receiving one or more bitstreams using an input (e.g., decoder input 132, I/O devices 152, etc.), providing audible speech or readable text based on the one or more bitstreams using an output (e.g., encoder output 116, I/O devices 152, etc.), identifying individual bitstreams of the one or more bitstreams, determining an occurrence of a transmission error based on a pair of phonemes corresponding to two sequential bitstreams of the received one or more bitstreams etc.

Systems for low data rate language communication may include a plurality of devices or nodes 170 as depicted in the system 168 of FIG. 3. Each of the plurality of nodes 170 may include an encoder (e.g., encoder 110 of FIG. 1), a decoder (e.g., decoder 130 of FIG. 1), or a combined encoder/decoder (e.g., encoder/decoder of FIG. 2). As shown, each of the nodes 170 includes may be a wireless communication device. However, each node of the nodes 170 may be any suitable communication or computing device such as, a radio, a mobile compute device, a personal computer, etc. Each of the nodes 170 may include apparatus or devices to facilitate low bitrate language communication. For example, each of the nodes 170 may include a display 172, a user interface 174, one or more acoustic transducers 176, and an antenna 178.

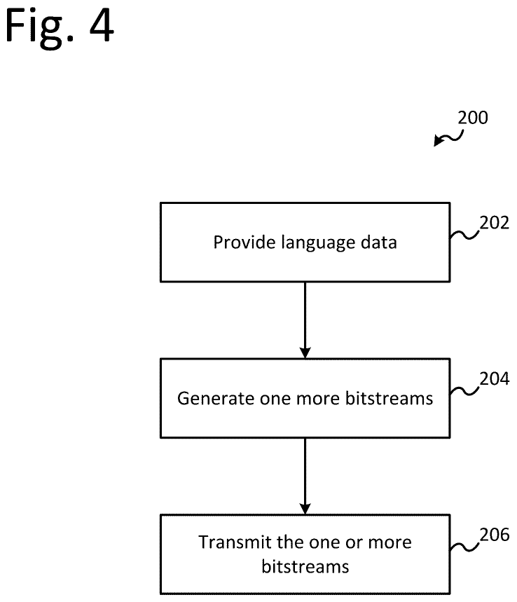

An exemplary technique, or process 200, for generating bitstreams for low bitrate communication is depicted in FIG. 4. The process 200 may include receiving 202 language data representative of audible speech or readable text, generating 204 one or more bitstreams, each of the one or more bitstreams representative of a single phoneme based on the received language data, and transmitting 206 the one or more bitstreams. Language data representative of audible speech or readable text may be received 202 using an input (e.g., encoder input 112 of FIG. 1, I/O devices 152 of FIG. 2, etc.). Audible speech may be received by an acoustic transducer (e.g., acoustic transducers 176) and converted to language data as an analog or digital signal that may be provided to processing circuitry (e.g., processing circuitry 114 of FIG. 1 or 154 of FIG. 2). The acoustic transducer may be a microphone that forms a portion of the input or is operatively coupled to the input. Readable text may be received via a user input (e.g., user interface 174) and converted to language data as an analog or digital signal that may be provided to the processing circuitry. The user input may include, for example, a keyboard, a graphical user interface, a speech-to-text encoder, a computer, or other device capable of providing readable text or text data. Additionally, the user input may form a portion of the input or may be operatively coupled to the input.

The one or more bitstreams may be generated 204 by processing circuitry (e.g., processing circuitry 114 of FIG. 1 or 154 of FIG. 2). Each of the one or more bitstreams may be suitable for representing or communicating a single phoneme corresponding to the audible speech or readable text. In general, a single phoneme may be represented by a bitstream or series of bits that is 6 bits long or less. In one or more embodiments, each of the one or more bitstreams may include 6 bits. In other words, each of the one or more bitstreams may be a fixed length bitstream having 6 bits. Alternatively, each of the one or more bitstreams may vary in length depending on the single phoneme that the bitstream represents. In one or more embodiments, each of the one or more bitstreams includes at least 4 bits and no greater than 6 bits. Additionally, each of the one or more bitstreams may be a raw bitstream. In other words, each of the one or more bitstreams may only include bits that represent a payload.

The one or more bitstreams may be transmitted 206 using an output (e.g., output 116 of FIG. 1 or transceiver 156 of FIG. 2). Furthermore, each of the one or more bitstreams may be transmitted at a low bitrate. For example, the one or more bitstreams may be transmitted at a rate of 30 bits per second or less. Additionally, the one or more bitstreams may be transmitted at 20 bits per second or less or 15 bits per second or less. Transmission of the one or more bitstreams may also include a transmission gap between each of the one or more bitstreams. In other words, the transmission of the one or more bitstreams may include a transmission gap between transmission of two sequential bitstreams of the one or more bitstreams. The transmission gap may be at least 1 millisecond and no greater than 10 milliseconds.

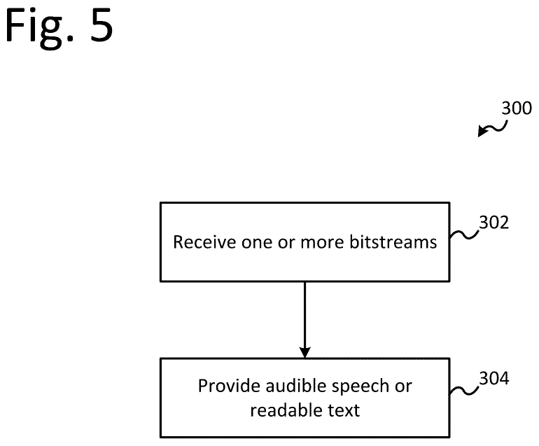

An exemplary technique, or process 300, for generating language information from bitstreams for low bitrate communication is depicted in FIG. 5. The process 300 may include receiving 302 one or more bitstreams, each of the one or more bitstreams representative of a single phoneme, and providing 304 audible speech or readable text based on the one or more bitstreams using a decoder output.

The one or more bitstreams may be received 302 using an input (e.g., decoder input 132 of FIG. 1, transceiver 156 of FIG. 2, etc.). One or more signals that represent or include the one or more bitstreams may be received using an antenna (e.g., antenna 178 of FIG. 3) or other input device capable of receiving communication signals. The one or more signals may be wired or wireless signals that include the one or more bitstreams. Each of the received one or more bitstreams may include the characteristics of the one or more bitstreams transmitted 206 according to the method or process 200 of FIG. 4. For example, the one or more bitstreams may have a transmission rate of 30 bits per second or less, 20 bits per second or less, or 15 bits per second or less. Additionally, a transmission gap may be included between each of the one or more bitstreams. The transmission gap may be at least 1 millisecond and no greater than 10 milliseconds.

The audible speech or readable text may be provided 304 using an output (e.g., output 136 of FIG. 1 or I/O devices 152 of FIG. 2). Audible speech may be provided using an acoustic transducer (e.g., acoustic transducers 176) to generate sound that includes each phoneme represented by the one or more bitstreams. Readable text may be provided using a display (e.g., display 172). The provision of audible speech and readable text may include generating one or more signals representative of the audible speech or the readable text based on the received one or more bitstreams and providing the one or more signals to the output. The one or more signals may be generated by or using processing circuitry (e.g., processing circuitry 134 of FIG. 1 or 154 of FIG. 2). In other words, the processing circuitry may receive the one or more bitstreams and convert the phonemes of the one or more bitstreams into signals for generating sound that includes the phonemes included in the one or more bitstreams or displaying readable text corresponding to the phonemes included in the one or more bitstreams.

The method 300 may also include determining an occurrence of a transmission error based on a pair of phonemes corresponding to two sequential bitstreams of the received one or more bitstreams. Such determination of the occurrence of a transmission error may be based on a language being spoken. In general, there are some phonemes in spoken language that may not occur sequentially. Accordingly, when the phonemes of two sequential bitstreams correspond to a phoneme order that should not occur in a given language it can be determined that a transmission error has occurred. In response to a determination that a transmission error occurred, a transmission error message may be provided using the output.

The methods 200 and 300 may be carried out or executed in isolation by a device or apparatus or the methods 200 and 300 may be carried out in combination by one or more apparatus and/or systems. For example, method 200 may be performed by an encoder apparatus (e.g., encoder apparatus 110 of FIG. 1, encoder/decoder apparatus 150 of FIG. 2, or a node 170 of FIG. 3) as a standalone device or as one node or apparatus in a system (e.g., system 100 of FIG. 1 or system 168 of FIG. 3). Additionally, method 300 may be performed by a decoder apparatus (e.g., decoder apparatus 130 of FIG. 1, encoder/decoder apparatus 150 of FIG. 2, or a node 170 of FIG. 3) as a standalone device or as one node or apparatus in a system (e.g., system 100 of FIG. 1 or system 168 of FIG. 3). Furthermore, the methods 200 and 300 in combination may be performed by a single device (e.g., encoder/decoder 150 of FIG. 2) or a system (e.g., system 100 of FIG. 1 or system 168 of FIG. 3).

All references and publications cited herein are expressly incorporated herein by reference in their entirety into this disclosure, except to the extent they may directly contradict this disclosure. Illustrative embodiments of this disclosure are described and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. An encoder apparatus comprising:
an encoder input to provide language data representative of audible speech or readable text;
an encoder output to transmit bitstreams; and
processing circuitry operatively coupled to the encoder input and the encoder output and configured to:
receive the language data from the encoder input;
generate one or more bitstreams based on the received language data, each of the one or more bitstreams representative of a single phoneme; and
transmit the one or more bitstreams using the encoder output.

2. The apparatus as in claim 1, wherein each of the one or more bitstreams is a raw bitstream.

3. The apparatus as in claim 1, wherein each of the one or more bitstreams comprises at least 4 bits and no greater than 6 bits.

4. The apparatus as in claim 1, wherein each of the one or more bitstreams comprises 6 bits.

5. The apparatus as in claim 1, wherein the processing circuitry is configured to transmit the one or more bitstreams at a rate of 30 bits per second or less.

6. The apparatus as in claim 1, wherein transmission of the one or more bitstreams comprises a transmission gap of at least 1 millisecond and no greater than 10 milliseconds between transmission of two sequential bitstreams of the one or more bitstreams.

7. The apparatus as in claim 1, wherein the encoder input comprises an audio transducer configured to receive the audible speech and provide the language data based on the audible speech.

8. The apparatus as in claim 1, wherein the encoder input comprises a user interface configured to receive user input representative of the readable text and provide the language data based on the user input.

9. A decoder apparatus comprising:
a decoder input to receive bitstreams, each bitstream representative of a single phoneme;
a decoder output to provide sound or readable text; and
processing circuitry operatively coupled to the decoder input and the decoder output and configured to:
receive one or more bitstreams using the decoder input; and
provide audible speech or readable text based on the one or more bitstreams using the decoder output.

10. The apparatus as in claim 9, wherein each of the one or more bitstreams are raw bitstreams.

11. The apparatus as in claim 9, wherein to provide the audible speech or the readable text, the processing circuitry is configured to:
generate one or more signals representative of the audible speech or the readable text based on the received one or more bitstreams; and
provide the one or more signals to the decoder output.

12. The apparatus as in claim 9, wherein the decoder output comprises a display and providing the audible speech or the readable text comprises displaying text representative of each phoneme represented by the one or more bitstreams using the display.

13. The apparatus as in claim 9, wherein the decoder output comprises an audio transducer configured to generate sound and providing the audible speech or the readable text comprises generating sound comprising each phoneme represented by the one or more bitstreams using the audio transducer.

14. The apparatus as in claim 9, wherein the processing circuitry is further configured to determine an occurrence of a transmission error based on a pair of phonemes corresponding to two sequential bitstreams of the received one or more bitstreams.

15. A system comprising:
an encoder configured to:
generate one or more bitstreams based on language data representative of audible speech or readable text, each of the one or more bitstreams representative of a single phoneme; and
transmit the one or more bitstreams; and
a decoder configured to:
receive the transmitted one or more bitstreams; and
provide the audible speech or the readable text based on the one or more bitstreams.

16. The system as in claim 15, wherein each of the one or more bitstreams comprises at least 4 bits and no greater than 6 bits.

17. The system as in claim 15, wherein transmitting the one or more bitstreams comprises transmitting the one or more bitstreams at a rate of 30 bits per second or less.

18. The system as in claim 15, wherein transmission of the one or more bitstreams comprises a transmission gap of at least 1 millisecond and no greater than 10 milliseconds between transmission of two sequential bitstreams of the one or more bitstreams.

19. The system as in claim 15, wherein the decoder comprises:
a decoder output; and
processing circuitry operatively coupled to the decoder output, wherein to provide the audible speech or the readable text, the processing circuitry is configured to:
generate one or more signals representative of the audible speech or the readable text based on the received one or more bitstreams; and
provide the one or more signals to the decoder output.

20. The system as in claim 15, wherein the decoder comprises a decoder output comprising an audio transducer and providing the audible speech or the readable text comprises generating sound that comprises each phoneme represented by the one or more bitstreams using the audio transducer.
